(19) United States
(12) Patent Application Publication
(10) Pub. No.: US 2017/0344249 A1
(43) Pub. Date: Nov. 30, 2017

(54) METHOD FOR CHANGING SIZE AND COLOR OF CHARACTER IN TOUCH INPUT DEVICE

(71) Applicant: HiDeep Inc., Gyeonggi-do (KR)

(72) Inventors: Seyeob Kim, Gyeonggi-do (KR); Yunjoung Kim, Gyeonggi-do (KR)

(21) Appl. No.: 15/604,885

(22) Filed: May 25, 2017

(30) Foreign Application Priority Data
May 27, 2016 (KR) 1020160065683

(51) Int. Cl. G06F 3/0488; G06F 3/0482; G06F 3/0484; G06T 11/20

(52) U.S. Cl. CPC G06F 3/04883; G06T 11/203; G06F 3/0482; G06F 3/04845; G06F 2203/04808

(57) ABSTRACT

A method for changing the size and color of a character in a touch input device including a controller and a touch input unit may be provided. The method includes: selecting, by the controller, a predetermined character in a display of the touch input unit; generating, by the controller, a pop-up window for changing at least one of the color and size of the selected predetermined character and displaying the generated pop-up window on the display; and changing, by the controller, at least one of the color and size of the selected character into at least one of the color and size selected by an object, and displaying the changed character on the display.

### CROSS REFERENCE TO RELATED APPLICATIONS

Priority is claimed under 35 U.S.C. §119 to Korean Patent Application No. 10-2016-0065683, filed May 27, 2016, the disclosure of which is incorporated herein by reference in its entirety.

### BACKGROUND

### Field

The present disclosure relates to a method for changing the size and color of a character in a touch input device and more particularly to a method for selectively changing the size and color of a predetermined character in accordance with the pressure magnitude of a touch on the touch input device, touch direction and/or a combination of touch positions.

### Description of the Related Art

Various kinds of input devices such as a button, key, joystick and touch screen, etc., are being developed and used to operate a computing system. The most attention is paid to the touch screen because the touch screen has a variety of advantages, e.g., ease of operation, miniaturization of products and simplification of the manufacturing process.

The touch screen may constitute a touch surface of a touch input device including a touch sensor panel. The touch sensor panel is attached to the front side of the touch screen and covers the touch screen. A user is able to operate the corresponding device by touching the touch screen with a finger, etc. The corresponding device detects whether the user touches or not and the touch position and performs operations, and thus, performs operations corresponding to the user's operation.

Most of the devices (e.g., a mobile terminal, PDA, etc.) employing the touch screen determines whether the user touches or not and the touch position, and performs specific operations. Specifically, when the user touches an area where an application is displayed, the corresponding device detects the position where the touch has occurred, and executes, drives or terminates the application. Each of the devices also executes the application on the basis of a touch holding time, the number of the touches, or patterns. For example, an object which is displayed can be variously performed by a long touch, double touch, multi touch or the like.

However, the above-described conventional touch control method performs a specific operation on the basis of the touch position, pattern, and time. Therefore, controllable operations are limited. At the current point of time when functions of various devices are integrated and gradually varied, there is a requirement for a new touch method capable of avoiding the conventional touch control method.

However, it is not easy to simultaneously realize a new touch method as well as the conventional touch control method as it is at the same time. Also, it is difficult to detect whether the user touches or not and the touch position at the same time without time division.

### BRIEF SUMMARY

One embodiment is a method for changing the size and color of a character in a touch input device including a controller and a touch input unit. The method includes: selecting, by the controller, a predetermined character in a display of the touch input unit; generating, by the controller, a pop-up window for changing at least one of the color and size of the selected predetermined character and displaying the generated pop-up window on the display; and changing, by the controller, at least one of the color and size of the selected character into at least one of the color and size selected by an object, and displaying the changed character on the display.

### BRIEF DESCRIPTION OF THE DRAWINGS

FIG. 1 is a block diagram showing a touch input device according to an embodiment of the present invention;

FIG. 2 is a cross sectional view of a first embodiment of a touch input unit 100 shown in FIG. 1;

FIG. 3 is a cross sectional view of a second embodiment of the touch input unit 100 shown in FIG. 1;

FIG. 4 is a cross sectional view of a third embodiment of the touch input unit 100 shown in FIG. 1;

FIGS. 5 to 7 show modified examples of a first electrode 41 and a second electrode 42;

FIG. 8 shows a display module 150A including an LCD panel, and FIG. 9 shows a display module 150B including an OLED panel;

FIGS. 10 to 12 are cross sectional views for describing a modified example of the touch input unit shown in FIG. 4;

FIG. 13 is a cross sectional view of a touch input unit according to another embodiment of the present invention;

FIG. 14 is a cross sectional view for describing a modified example of the touch input unit shown in FIG. 13 in accordance with the embodiment of the present invention;

FIG. 15 is a cross sectional view of a touch input unit according to further another embodiment of the present invention;

FIG. 16 is a flowchart of a method for changing at least one of the size and color of a character displayed based on a touch pressure in accordance with the embodiment of the present invention;

FIGS. 17 to 21 are views for describing the method shown in FIG. 16 for changing at least one of the size and color of the character displayed based on the touch pressure in accordance with the embodiment of the present invention; and

FIGS. 22 to 28 are views for describing another method shown in FIG. 16 for changing at least one of the size and color of the character displayed based on the touch pressure in accordance with the embodiment of the present invention.

### DETAILED DESCRIPTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. Therefore, the following detailed description is not intended to be limited. If adequately described, the scope of the present invention is limited only by the appended claims of the present invention as well as all equivalents thereto. Similar reference numerals in the drawings designate the same or similar functions in many aspects.

Terms used in variously described embodiments of the present specification are provided for only the description of specific embodiments, and not intended to be limiting. As used in the description of the variously described embodiments and the appended claims, singular forms (“a”, “an”, and “the”) are intended to include plural forms as well, unless expressly described otherwise. It will be understood that the term of “and/or” used in the present specification represents and includes any and all possible combinations of one or more of related items mentioned. While the terms “include”, “including”, “comprise” used in the present specification specify the existences of characteristics, essentials, steps, operations, elements, and/or components stated, it will be further understood that the existences or additions of one or more other characteristics, essentials, steps, operations, elements, components and/or groups thereof are not excluded.

Hereinafter, a touch input device including a touch screen will be described. However, it should be understood that the touch input device selectively includes one or more other physical user interface devices such as a physical keyboard, mouse and/or joystick.

Typically, the touch input device supports a variety of applications, such as a drawing application, a presentation application, a word processing application, a web-site creation application, a disc production application, a spreadsheet application, a game application, a telephone application, a video conferencing application, an e-mail application, an instant messaging application, an exercise support application, a picture management application, a digital camera application, a digital video camera application, a web browsing application, a digital music player application, and/or a digital video player application.

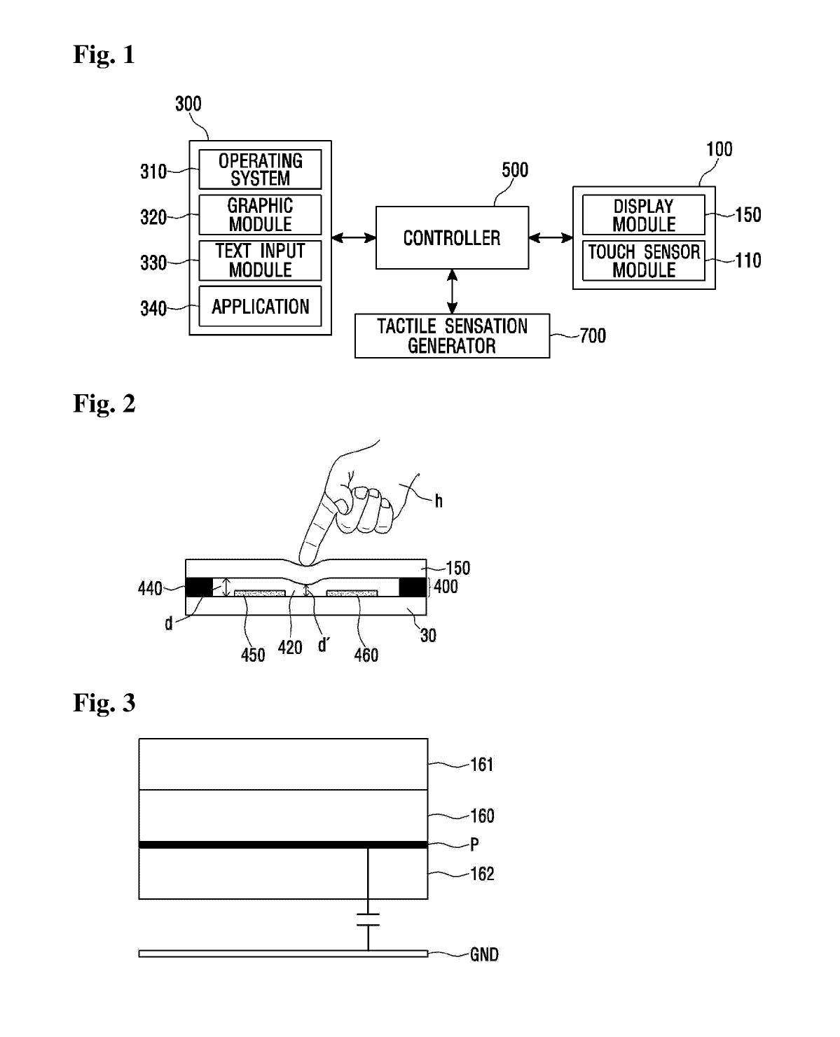

FIG. 1 is a block diagram showing a touch input device according to an embodiment of the present invention.

Referring to FIG. 1, the touch input device according the embodiment of the present invention may include a touch input unit 100, a memory 300, a controller 500, and a tactile sensation generator 700.

The touch input unit 100 includes a touch sensor module 110 and a display module 150.

The touch input unit 100 functions as a display means. For this purpose, the touch input unit 100 includes the display module 150. The display module 150 displays visual outputs to a user. The visual output selectively includes graphics, text, icons, video, and any combination of them (collectively referred to as “graphics”).

The touch input unit 100 functions as an input means. For this purpose, the touch input unit 100 includes the touch sensor module 110. Here, the function as an input means detects touch information which is input to the touch input unit 100.

The touch information includes 2D touch information and 3D touch information. That is, the touch information includes 2D touch information on whether or not the touch is input (whether or not the touch occurs), and on which position in the surface of the touch input unit 100 the touch is input to (the touch position). Moreover, the touch information may further include information on whether or not the touch is the 2D touch and on whether or not the touch is the 3D touch with a pressure having a magnitude greater than a predetermined magnitude. Here, 3D touch information may mean a touch having a sufficient pressure for the surface of the touch input unit 100 to be bent.

The touch input unit 100 may be designated as a so-called “touch and pressure sensitive touch screen”.

The term “strength” of the touch on the surface of the touch input unit 100 refers to a force or pressure (force per unit area) of the touch (e.g., finger touch) on the surface of the touch input unit 100. The strength of the touch includes at least four different values, and more typically has a variety of values including several hundred different values (e.g., at least 256 values). The strength of the touch is determined (or measured) by selectively using various approaches and various sensors or a combination of the sensors. For example, one or more pressure sensors which are adjacent to or under the surface of the touch input unit 100 are selectively used, thereby measuring the force at various points on the surface of the touch input unit 100. The size of the touch area and/or the change of the touch area, which has been detected on the surface of the touch input unit 100, a capacitance of a touch-sensitive surface and/or the change of the touch-sensitive surface in the vicinity of the touch, and/or a surface resistance and/or the change of the surface resistance in the vicinity of the touch are selectively used as a substitute for the force or pressure of the touch on the surface of the touch input unit 100.

The touch sensor module 110 of the touch input unit 100 may be disposed on or under the display module 150. Also, the touch sensor module 110 may be embedded in the display module 150. The detailed embodiments of the touch input unit 100 will be described below with reference to the accompanying drawings.

The touch input unit 100 uses a liquid crystal display (LCD) technology, a luminescent polymer display (LDP) technology, or a light emitting diode (LED) technology. Also, other display technologies may be used in other embodiments.

The touch input unit 100 and the controller 500 (together with any related modules and/or sets of instructions within the memory 300) detect the touch (and any movement or stopping of the touch) on the touch input unit 100, and converts the detected touch into user interface objects (e.g., one or more soft keys, icons, web pages or images) displayed by the display module 150 of the touch input unit 100.

In order to selectively determine one or more touch points with the touch input unit 100, the touch input unit 100 and the controller 500 include proximity sensor arrays or other components which are different from the capacitance, resistance, infrared rays, and surface acoustic wave technologies. However, the touch input unit 100 and the controller 500 detect the touch and any movement or stopping of the touch by using any one among a plurality of touch sensing technologies which are not limited to the above arrays or components and are currently known or to be developed in the future.

The touch input unit 100 selectively has a video resolution exceeding 100 dpi. In some embodiments, the touch input unit 100 has a video resolution of about 160 dpi. The user touches the touch input unit 100 by selectively using any suitable object such as a stylus, a finger, etc., or accessories. In some embodiments, a user interface is designed to work by mainly using finger-based touch and gestures. This may be less precise than the stylus-based input due to the wider touch area of the finger on the touch input unit 100. In some embodiments, the touch input device converts a rough finger-based input into a precise pointer/cursor position or command for performing actions that the user wants.

Hereinafter, the structure of the touch input unit 100 will be described with reference to FIGS. 2 to 13.

FIG. 2 is a cross sectional view of a first embodiment of the touch input unit 100 shown in FIG. 1.

As shown in FIG. 2, pressure electrodes 450 and 460 according to the first embodiment of the present invention may be formed within a spacer layer 420 and on a substrate 30.

The pressure electrodes 450 and 460 for pressure detection may include the first electrode 450 and the second electrode 460. Any one of the first and the second electrodes 450 and 460 may be a drive electrode and the other may be a receiving electrode. A driving signal is applied to the drive electrode, and a sensing signal may be obtained through the receiving electrode. When a voltage is applied, a mutual capacitance may be generated between the first electrode 450 and the second electrode 460.

The bottom surface of the display module 150 may have a ground potential for blocking noise. When pressure is applied to the surface of the touch sensor module 110 of FIG. 1 by an object “h”, the touch sensor module 110 and the display module 150 may be bent. Accordingly, a distance “d” between the ground potential surface and the pressure electrodes 450 and 460 may be reduced to a distance “d′”. In this case, due to the reduction of the distance “d”, fringing capacitance is absorbed in the bottom surface of the display module 150, so that the mutual capacitance between the first electrode 450 and the second electrode 460 may be reduced. Therefore, the magnitude of the touch pressure can be calculated by obtaining the reduction amount of the mutual capacitance from the sensing signal obtained through the receiving electrode.

The display module 150 may be bent by the touch applying the pressure. The display module 150 may be bent in such a manner as to show the biggest transformation at the touch position. When the display module 150 is bent according to the embodiment, a position showing the biggest transformation may not match the touch position. However, the display module 150 may be shown to be bent at least at the touch position. For example, when the touch position approaches close to the border, edge, etc., of the display module 150, the most bent position of the display module 150 may not match the touch position, however, the display module 150 may be shown to be bent at least at the touch position.

The top surface of the substrate 30 may also have the ground potential for blocking noise. Accordingly, the pressure electrodes 450 and 460 may be formed on an insulation layer (not shown) in order that the substrate 30 and the pressure electrodes 450 and 460 are prevented from being short-circuited. According to the embodiment, the insulation layer (not shown) on which the pressure electrodes 450 and 460 have been formed is attached to the substrate 30. Also, the pressure electrodes 450 and 460 according to the embodiment may be formed by positioning a mask, which has a through-hole corresponding to a pressure electrode pattern, on the substrate 30 or on the insulation layer (not shown) on the substrate 30, and then by spraying a conductive material.

When the bottom surface of the display module 150 has the ground potential, the insulation layer (not shown) may be disposed on the pressure electrodes 450 and 460 in order to prevent the display module 150 and the pressure electrodes 450 and 460 which are located on the substrate 30 are prevented from being short-circuited.

The insulation layer may be disposed on and under the pressure electrodes 450 and 460 such that the pressure electrodes 450 and 460 are positioned between the insulation layers respectively. The two insulation layers and the pressure electrodes 450 and 460 may form one pressure sheet.

Depending on the type and/or implementation method of the touch input unit 100 of FIG. 1, the substrate 30 or the display module 150 to which the pressure electrodes 450 and 460 are attached may not have the ground potential or may have a weak ground potential. In this case, the touch input unit 100 shown in FIG. 1 may further include a ground electrode (not shown) between the insulation layer (not shown) and the substrate 30 or between the insulation layer (not shown) and the display module 150. According to the embodiment, another insulation layer (not shown) may be included between the ground electrode and the substrate 300 or between the ground electrode and the display module 150. Here, the ground electrode (not shown) is able to prevent the size of the capacitance generated between the first electrode 450 and the second electrode 460, which are pressure electrodes, from increasing excessively.

An adhesive tape 440 with a predetermined thickness may be formed along the border of the upper portion of the substrate 30 in order to maintain the spacer layer 420. The adhesive tape 440 may be a double adhesive tape. The adhesive tape 440 may be made of an inelastic material. In the embodiment of the present invention, when a pressure is applied to the display module 150, the display module 150 may be bent. Therefore, the magnitude of the touch pressure can be detected even though the adhesive tape 440 is not transformed by the pressure.

Meanwhile, though not shown in a separate drawing, the pressure electrodes 450 and 460 may be disposed on the bottom surface of the display module 150. Here, substrate 30 may have the ground potential. Therefore, the distance “d” between the substrate 30 and the pressure electrodes 450 and 460 is reduced by touching the touch surface of the touch sensor module 110 of FIG. 1. Consequently, this may cause the change of the mutual capacitance between the first electrode 450 and the second electrode 460. Through this, the magnitude of the touch pressure can be calculated. Also, the self-capacitance of the pressure electrodes 450 and 460 is changed due to the change of the distance between the pressure electrodes 450 and 460 and the substrate 30 as a reference potential layer. Through obtaining information on such a change of the capacitance, the magnitude of the touch pressure can be calculated.

Meanwhile, though not shown in a separate drawing, any one of the first electrode 450 and the second electrode 460 may be formed on the substrate 30, and the other may be formed under the display module 150. A distance between the first electrode 450 and the second electrode 460 is reduced by the force caused by the object “h”. Due to the reduction of the distance, the mutual capacitance between the first electrode 450 and the second electrode 460 is changed. The reduction amount of the mutual capacitance is obtained by the sensing signal obtained by the receiving electrode of any one of the first electrode 450 and the second electrode 460, so that the magnitude of the touch pressure can be calculated.

FIG. 3 is a cross sectional view of a second embodiment of the touch input unit 100 shown in FIG. 1.

The touch input unit 100 shown in FIG. 3 has a structure in which a pressure electrode “P” is disposed within the display module 150 shown in FIG. 1.

As shown in FIG. 3, OLED display modules 160, 161, and 162 include an organic material layer 160 between the first substrate layer 161 and the second substrate layer 162. The pressure electrode “P” for detecting the touch pressure in the self-capacitance type may be formed on the top surface of the second substrate layer 162. The pressure electrode “P” may use a light shield (LS) for blocking light inflow, a gate electrode, a source electrode, a drain electrode, a pixel electrode, etc. In some cases, a separate metallic material is deposited on the pressure electrode “P”, and the pressure electrode “P” can be also used in the pressure detection. Furthermore, a separate structure made of a metallic material is provided to the pressure electrode “P”, and the pressure electrode “P” can be also used in the pressure detection.

Meanwhile, though not shown in a separate drawing, the pressure electrode “P” may be formed on the top surface or bottom surface of the first substrate layer 161 or may be formed on the bottom surface of the second substrate layer 162.

The reference potential layer (GND) shown in FIG. 3 may be substituted by the pressure electrode for pressure detection. For convenience of description, the pressure electrode “P” shown in FIG. 3 is referred to as a first pressure electrode, and the pressure electrode substituted for the reference potential layer (GND) is referred to as a second pressure electrode. The mutual capacitance change amount based on the change of the distance between the first pressure electrode “P” and the second pressure electrode is received through any one of the first pressure electrode “P” and the second pressure electrode, so that the touch pressure can be detected.

Meanwhile, though not shown in a separate drawing, the touch input unit 100 shown in FIG. 1 is also able to detect the touch pressure without a separate pressure electrode by using the drive electrode for driving the display module 150 or a touch electrode for detecting the touch position of the touch sensor module 110.

For example, the first pressure electrode “P” of FIG. 3 may be the touch electrode of the touch input unit 100 of FIG. 1. The touch position which is input to the touch input unit 100 can be detected through the touch electrode “P”. The touch pressure can be also detected by detecting the change of the mutual capacitance or self-capacitance based on the distance change between the touch electrode “P” and the reference potential layer (GND). Here, in order to detect the touch position and touch pressure by means of one touch pressure “P”, two or more driving signals (driving signal for detecting the touch position/driving signal for detecting the touch pressure) which are input to one touch electrode “P” may be distinguished from each other and applied at different times.

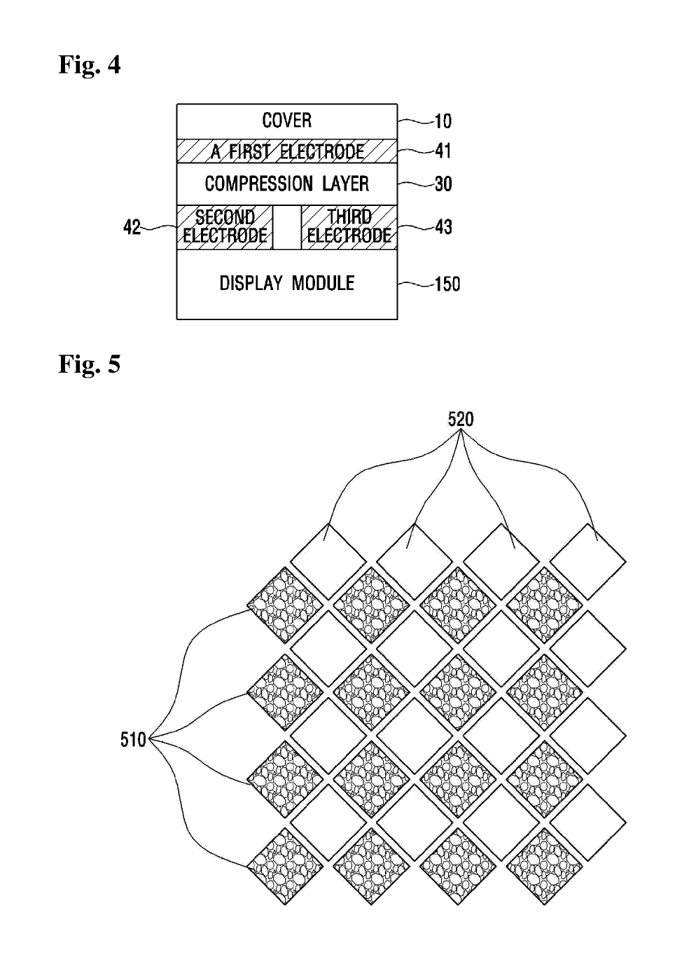

FIG. 4 is a cross sectional view of a third embodiment of the touch input unit 100 shown in FIG. 1.

Referring to FIG. 4, the touch input unit 100 according to the third embodiment may include a cover 10, a first electrode 41 disposed under the cover 10, a compression layer 30 disposed under the first electrode 41, a second electrode 42 and a third electrode 43 which are disposed under the compression layer 30, and the display module 150 disposed under the second electrode 42 and the third electrode 43.

The cover 10 is a member to which the touch is input by an input means such as a user's finger or object. The cover 10 may be located on the top of the touch input unit 100. The cover 10 functions to protect the components disposed thereunder.

The cover 10 may be made of a transparent material such as glass or plastic such that an image output from the display module 150 disposed under the cover 10 is visible to the outside.

The cover 10 may be made of a flexible material which can be bent at least at a position where the pressure is applied, such that the compression layer 30 to be described later is compressed when a pressure is applied to the cover 10.

The first electrode 41 may be disposed under the cover 10, and the second electrode 42 may be disposed under the first electrode 41. The third electrode 43 may be disposed, together with the second electrode 42, in the same layer.

As shown in FIG. 5, the second electrode 42 and the third electrode 43 may be comprised of a plurality of lozenge-shaped electrodes. Here, the second electrode 42 is a plurality of first axis electrodes 510 which are connected to each other in a first axial direction, and the third electrode 43 is a plurality of second axis electrodes 520 which are connected to each other in a second axial direction orthogonal to the first axial direction. In at least one of the second electrode 42 and the third electrode 43, the plurality of the lozenge-shaped electrodes are connected respectively through a bridge, so that the second electrode 42 and the third electrode 43 may be insulated from each other.

As shown in FIG. 5, the second electrode 42 and the third electrode 43 are comprised of the plurality of the first axis electrodes 510 and the plurality of the second axis electrodes 520. Therefore, the second electrode 42 and the third electrode 43 may be arranged without crossing each other such that the third electrodes 43 are connected respectively in a direction crossing the extension direction of the second electrode 42.

Since the first electrode 41 and the second electrode 42, or the first electrode 41 and the third electrode 43 are located in different layers, they can be implemented so as to overlap each other. For example, the first electrode 41 and the second electrode 42, or the first electrode 41 and the third electrode 43 may be, as shown in FIG. 5, comprised of the plurality of the first axis electrodes 510 and the plurality of the second axis electrodes 520 respectively, and may be arranged to cross each other. Alternatively, as shown in FIG. 4, the first lozenge-shaped axis electrode 510 and the second lozenge-shaped axis electrode 520 may be located in different layers.

The first electrode 41 may be directly formed on the bottom surface of the cover 10. Likewise, the second electrode 42 and the third electrode 43 may be directly formed on the top surface of the display module 150. Specifically, the second electrode 42 and the third electrode 43 may be directly formed on the top surface of below-described first substrate layers 151 and 161 of the display module 150. Here, the first electrode 41, the second electrode 42, and the third electrode 43 may be made of a transparent conductive material (e.g., Indium Tin Oxide (ITO) or Antimony Tin Oxide (ATO)), etc. Also, an insulation layer (not shown) made of a plastic-made thin transparent film such as Polyethylene terephthalate (PET) may be disposed between the cover 10 and the first electrode 41, between the first electrode 41 and the compression layer 30, between the compression layer 30, the second electrode 42, and the third electrode 43, or between the second electrode 42, the third electrode 43, and the display module 150. Here, the insulation layer protects the electrodes disposed under the cover 10 even though the cover 10 is damaged by external impact, thereby functioning to maintain the touch input operation. Here, an optical clear adhesive (OCA, not shown) is located between the insulation layer and the electrode or between the electrode and the compression layer 30, so that they can be adhered to each other.

The compression layer 30 is made of a material which is pressed when a pressure is applied to the cover 10, and restores its original state when the applied pressure is released. The faster the restoring force is, the higher the pressure detection accuracy can be. The compression layer 30 may be made of silicone, acryl, or other compressible elastic bodies. The compression layer 30 may be made of a transparent material such that an image output from the display module 150 is visible to the outside because the compression layer 30 is disposed on the display module 150.

Though not shown in the drawing, the position of the first electrode 41 may be changed into the positions of the second electrode 42 and the third electrode 43, and the positions of the second electrode 42 and the third electrode 43 may be changed into the position of the first electrode 41.

The display module 150 includes any one of a liquid crystal display (LCD) panel, a plasma display panel (PDP), and an organic light emitting diode (OLED) panel. Accordingly, the user is able to perform the input operation by touching the surface of the touch input unit 100 while visually checking the screen of the display module 150. Here, the display module 150 may include a control circuit which receives an input from an application processor (AP) or a central processing unit (CPU) on a main board for the operation of the touch input device and displays the contents that the user wants on the screen of the display module 150. The control circuit may be mounted on a second printed circuit board (hereafter, referred to as a second PCB). Here, the control circuit for the operation of the display module 150 may include a display panel control IC, a graphic controller IC, and a circuit required to operate other display panels.

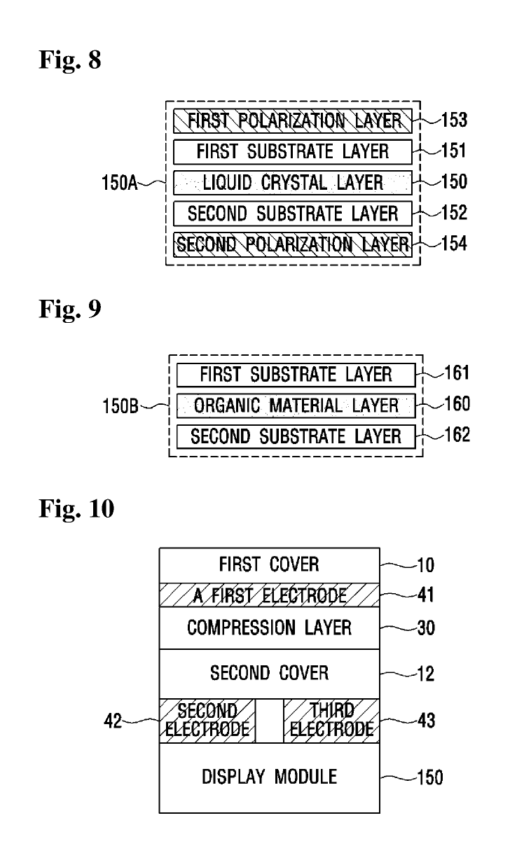

FIG. 8 shows a display module 150A including the LCD panel, and FIG. 9 shows a display module 150B including the OLED panel.

As shown in FIG. 8, the display module 150A may include a liquid crystal layer 150 including a liquid crystal cell, the first substrate layer 151 and a second substrate layer 152 which are disposed on both sides of the liquid crystal layer 150 and include electrodes, a first polarization layer 153 formed on a side of the first substrate layer 151 in a direction facing the liquid crystal layer 150, and a second polarization layer 154 formed on a side of the second substrate layer 152 in the direction facing the liquid crystal layer 150. It is clear to those skilled in the art that the LCD panel may further include other structures for the purpose of performing the displaying function and may be transformed. Here, the first substrate layer 151 may be color filter glass, and the second substrate layer 152 may be TFT glass.

Here, the display module 150A including the LCD panel may include a backlight unit (not shown) disposed under the second polarization layer 154. The display module 150A, which is the LCD panel, itself cannot emit light and functions to block or transmits the light. Therefore, a light source is disposed under the display module 150A and throws light on the display module 150A, so that the screen displays information with various colors as well as brightness and darkness. A light source having a uniform luminance distribution is required on the rear side because the display module 150A, which is the LCD panel, is a passive device and itself cannot emit the light.

As shown in FIG. 9, the display module 150B may include the organic material layer 160, the first substrate layer 161 and the second substrate layer 162 both of which are located on both sides of the organic material layer 160. It is clear to those skilled in the art that the OLED panel may further include other structures for the purpose of performing the displaying function and may be transformed. Here, the first substrate layer 161 may be encapsulation glass, and the second substrate layer 162 may be TFT glass.

FIGS. 10 to 12 are cross sectional views for describing a modified example of the touch input unit shown in FIG. 4.

As shown in FIG. 10, the touch input unit may further include a second cover 12. Here, the second cover 12 may be made of a transparent material such as glass or plastic such that an image output from the display module 150 disposed under the second cover 12 is visible to the outside. Also, the second cover 12 may be made of a material which is relatively more solid than that of the first cover 10 or may be formed thicker than the first cover 10 such that the second cover 12 is not bent even by a pressure applied to the second cover 12.

The structures of the second cover 12, the second electrode 42, the third electrode 43, and the display module 150 of the touch input unit shown in FIG. 10 is the same as those of a conventional touch input device which does not detect the touch pressure. Accordingly, it is possible to implement the touch input unit capable of detecting the touch pressure by adding a touch pressure detection module composed of the first cover 10, the first electrode 41, and the compression layer 30 to the conventional touch input unit. Therefore, there is no need to change the structure of the conventional touch input unit and reliability can be easily obtained.

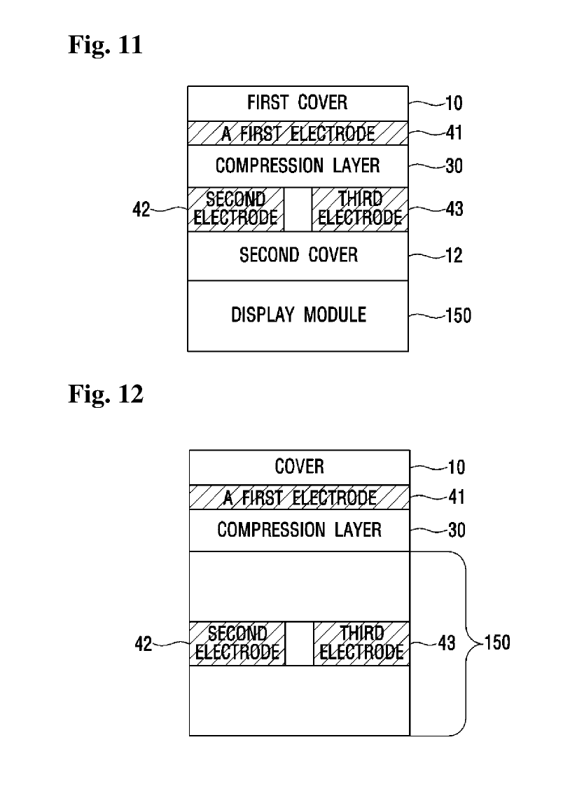

As shown in FIG. 11, in the touch input unit according to the embodiment of the present invention, the second electrode 42 and the third electrode 43 are disposed between the compression layer 30 and the second cover 12.

In the touch input unit shown in FIG. 11, a module which is composed of the first cover 10, the first electrode 41, the compression layer 30, the second electrode 42, the third electrode 43, and the second cover 12 and detects the touch position and the touch pressure is completely separated from the display module 150. Therefore, the display module 150 and the module for detecting the touch position and the touch pressure can be replaced separately from each other.

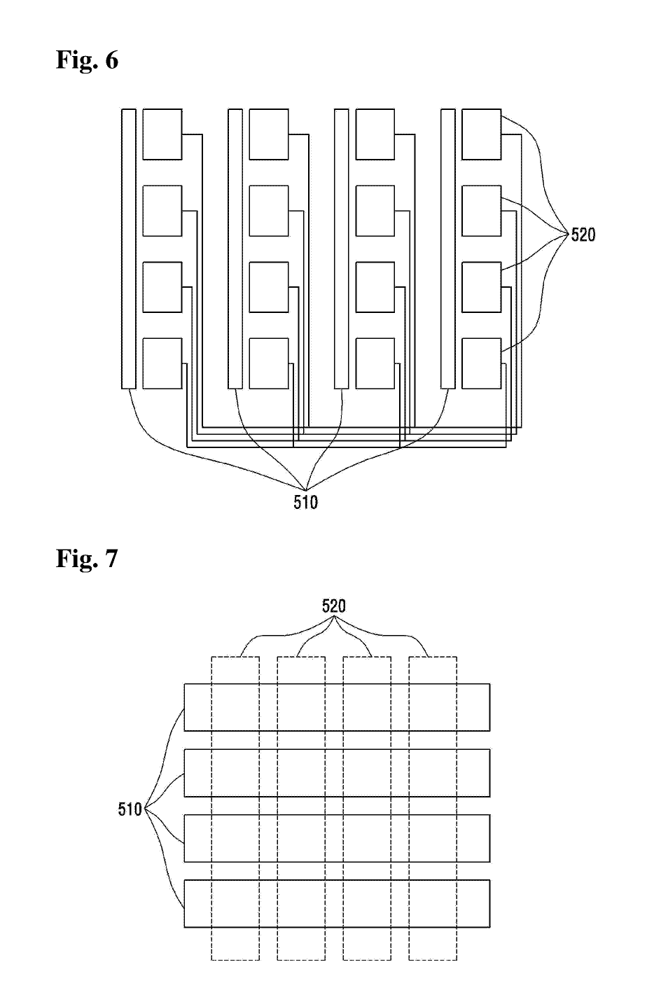

Unlike the touch input unit shown in FIG. 2, in the touch input unit shown in FIG. 12, the second electrode 42 and the third electrode 43 may be disposed within the display module 150. The second electrode 42 and the third electrode 43 may be disposed between the liquid crystal layer 150 and the second substrate layer 152 which are shown in FIG. 6.

Though not shown in the drawings, in the touch input unit shown in FIGS. 10 to 12, the position of the first electrode 41 may be changed into the positions of the second electrode 42 and the third electrode 43, and the positions of the second electrode 42 and the third electrode 43 may be changed into the position of the first electrode 41.

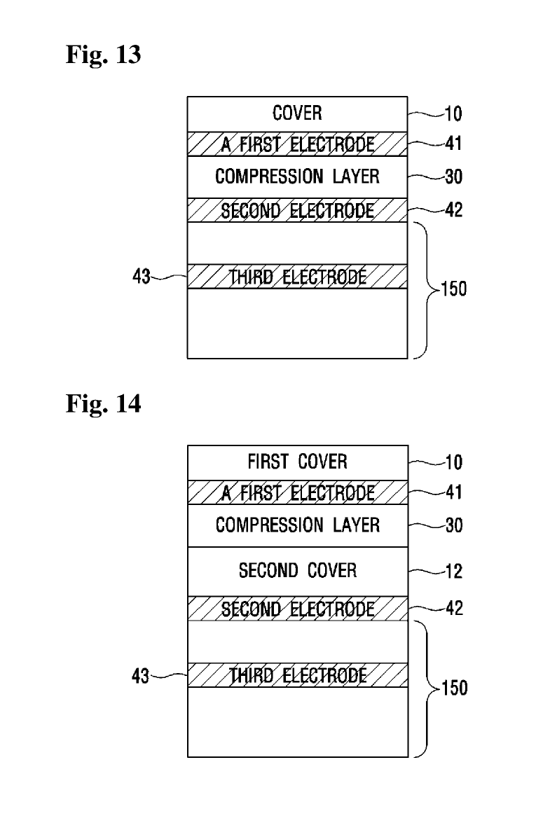

FIG. 13 is a cross sectional view of a touch input unit according to another embodiment of the present invention. The touch input unit shown in FIG. 13 may include the cover 10, the first electrode 41 disposed under the cover 10, the compression layer 30 disposed under the first electrode 41, the second electrode 42 disposed under the compression layer 30, the display module 150 disposed under the second electrode 42, and the third electrode 43 disposed within the display module.

FIG. 14 is a cross sectional view for describing a modified example of the touch input unit shown in FIG. 13 in accordance with the embodiment of the present invention.

As shown in FIG. 14, the touch input device may further include the second cover 12. Here, the second cover 12 may be made of a transparent material such as glass or plastic such that an image output from the display module 150 disposed under the second cover 12 is visible to the outside. Also, the second cover 12 may be made of a material which is relatively more solid than that of the first cover 10 or may be formed thicker than the first cover 10 such that the second cover 12 is not bent even by a pressure applied to the second cover 12. Regarding the touch input unit shown in FIG. 11, it is possible to implement the touch input unit capable of detecting the touch pressure by adding a touch pressure detection module composed of the first cover 10, the first electrode 41, and the compression layer 30 to the conventional touch input unit. Therefore, there is no need to change the structure of the conventional touch input unit and reliability can be easily obtained.

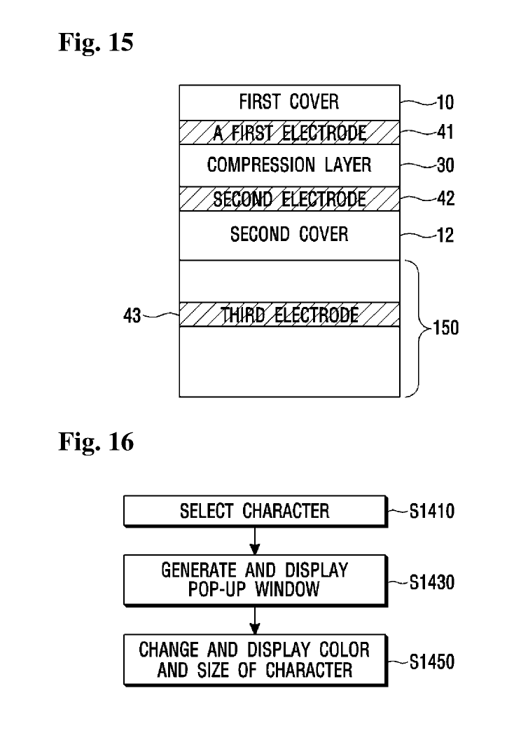

As shown in FIG. 15, the touch input unit according to the embodiment of the present invention may include the first cover 10, the first electrode 41 disposed under the cover 10, the compression layer 30 disposed under the first electrode 41, the second electrode 42 disposed under the compression layer 30, the second cover 12 disposed under the second electrode 42, the display module 150 disposed under the second cover 12, and the third electrode 43 disposed within the display module 150. In the touch input unit shown in FIG. 12, a module which is composed of the first cover 10, the first electrode 41, the compression layer 30, the second electrode 42, and the second cover 12 and detects the touch position and the touch pressure is completely separated from the display module 150. Therefore, the display module 150 and the module for detecting the touch position and the touch pressure can be replaced separately from each other.

It should be noted that the detailed structure of the touch input unit 100 shown in FIG. 1 is not limited to those shown in FIGS. 2 to 15. It should be understood that the detailed structure of the touch input unit 100 shown in FIG. 1 includes not only those shown in FIGS. 2 to 15 but also any structure capable of detecting the touch pressure.

Referring back to FIG. 1, the memory 300 will be described.

The memory 300 selectively includes a high speed random access memory, and also selectively includes one or more magnetic disk storage devices, flash memory devices, or a non-volatile memory such as other non-volatile solid state memory device.

The memory 300 includes one or more computer-readable components. Specifically, the memory 300 includes an operating system 310, a graphic module 320, a text input module 330, and an application 340.

The operating system 310 may be, for example, an embedded operating system such as Darwin, RTXC, LINUX, UNIX, OS X, WINDOWS, or VxWorks. The operating system 310 includes a variety of software components and/or drivers for controlling and managing general system tasks (e.g., memory management, storage device control, power management, etc.) facilitates communications between various hardware and software components

The graphic module 320 includes components for changing visual impacts (e.g., brightness, transparency, saturation, contrast, or other visual attributes) of a graphic to be displayed on the touch input unit 100 and includes a variety of known software components for rendering and displaying the graphic on other displays. As used in this specification, the term “graphic” includes any object which can be displayed to the user and includes texts, web pages, icons (e.g., user interface objects including soft keys), digital images, videos, animations, etc., without limitation.

The text input module 330 provides a soft keyboard for inputting a text to the application 340.

The applications 340 may include not only a browser, an address book, a contact list, email, instant messaging, word processing, keyboard emulation, widget, JAVA-supported applications, encryption, digital right management, voice recognition, voice replication, location determination capability (that is provided by a global positioning system (sometimes referred to as “GPS” in this specification), etc.), a music player, etc., (not limited to these), but also any application which is installed on the memory 300.

Besides, the memory 140 may facilitate communications with other devices through at least one external port and include a communication module including a variety of software components for processing data received by an RF circuit and/or external ports.

The controller 500 detects the position and pressure of the touch which is input to the touch input unit 100.

The controller 500 may include a drive unit which applies a touch position driving signal and a touch pressure driving signal to the touch input unit 100, and a sensing unit which receives a touch position sensing signal and a touch pressure sensing signal. Here, for example, any one of the touch position sensing signal and the touch pressure sensing signal may be based on any one among the capacitance between the first electrode 41 and the second electrode 42 shown in FIGS. 4 to 15, the capacitance between the second electrode 42 and the third electrode 43, and the capacitance between the third electrode 43 and the first electrode 41. The other of the touch position sensing signal and the touch pressure sensing signal may be based on any one of the remaining capacitances other than the above one among the capacitance between the first electrode 41 and the second electrode 42, the capacitance between the second electrode 42 and the third electrode 43, and the capacitance between the third electrode 43 and the first electrode 41. The controller 500 detects the touch position on the basis of the touch position sensing signal and detects the touch pressure on the basis of the touch pressure sensing signal.

On the basis of the detected position information and pressure information of the touch, the controller 500 changes at least one of the size and color of a character displayed on the display module 150 of the touch input unit 100. How the controller 500 specifically changes at least one of the size and color of a character displayed on the display module 150 will be described in detail in FIG. 16 and later figures.

The controller 500 controls and manages the touch input unit 100, the memory 300, and tactile sensation generator 700. The controller 500 may request the information from the touch input unit 100, the memory 300, and tactile sensation generator 700 or may cause the touch input unit 100, the memory 300, and tactile sensation generator 700 to change the information.

The tactile sensation generator 700 selectively includes one or more electroacoustic devices such as speakers or other audio components, and/or electromechanical devices which convert energy into a linear motion, such as a motor, solenoid, electroactive polymer, piezoelectric actuator, electrostatic actuator, or other tactile output generating components (e.g., a component converting electrical signals into tactile outputs on the device).

The tactile sensation generator 700 receives tactile feedback generating instructions from the controller 500 and generates tactile outputs which can be sensed by the user who uses the touch input device. In some embodiments, at least one tactile sensation generator 700 is located together with the touch input unit 100 or is adjacent to the touch input unit 100. The tactile sensation generator 700 may selectively move perpendicular to the surface of the display of the touch input unit 100 (e.g., into or out of the surface of the touch input device) or in a lateral direction (e.g., forward and backward within the same plane as the surface of the touch input device), so that the tactile output is generated.

The tactile sensation generator 700 is an additional component and may not be included in the touch input device according to the embodiment of the present invention.

The touch input device according to the embodiment of the present invention is just an example of a portable electronic device such as a smartphone. The touch input device may have a larger or smaller number of components than those shown in FIG. 1 or may selectively have a combination of two or more components, or may selectively have different configurations or arrangements of the components. Various components shown in FIG. 1 can be implemented by hardware, software, or a combination of both hardware and software as well as by one or more signal processing and/or an application specific integrated circuit.

Hereinafter, a method for changing at least one of the size and color of a character displayed based on the touch pressure in accordance with the embodiment of the present invention will be described with reference to FIG. 16 and later figures.

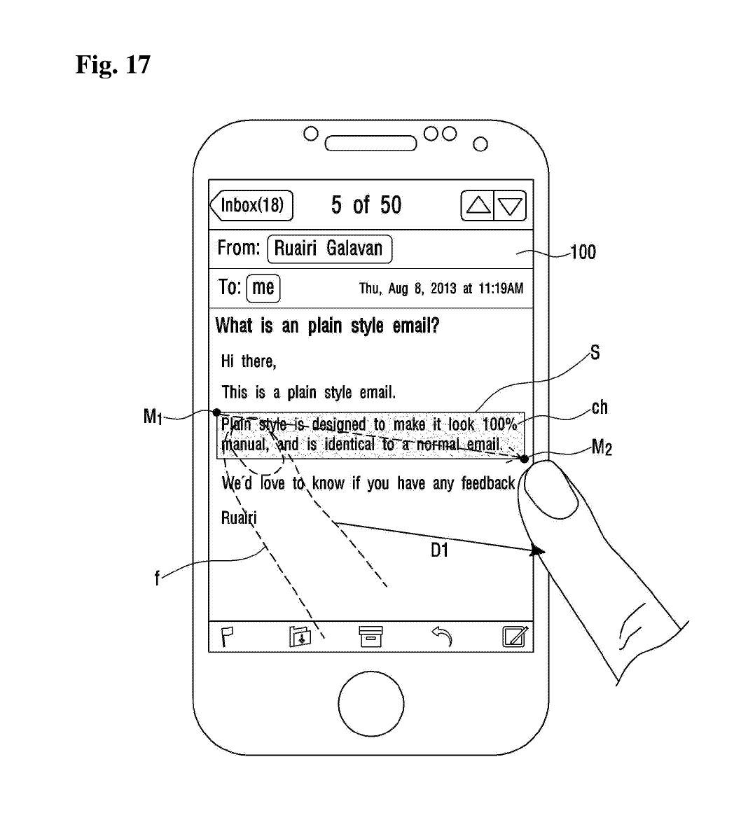

FIG. 16 is a flowchart of a method for changing at least one of the size and color of a character displayed based on the touch pressure in accordance with the embodiment of the present invention. FIGS. 17 to 21 are views for describing the method shown in FIG. 16 for changing at least one of the size and color of the character displayed based on the touch pressure in accordance with the embodiment of the present invention.

Referring to FIG. 16, the method for changing at least one of the size and color of a character displayed based on the touch pressure in accordance with the embodiment of the present invention includes selecting a predetermined character in the display of the touch input unit (S1410), generating a pop-up window for changing the color and size of the selected predetermined character and displaying the pop-up window on the display (S1430), and changing the color and size of the character into the color and size selected by the user and displaying on the display (S1450).

The controller 500 shown in FIG. 1 detects the position and pressure of the touch input to the touch input unit 100, thereby performing the above steps. This will be described below in detail.

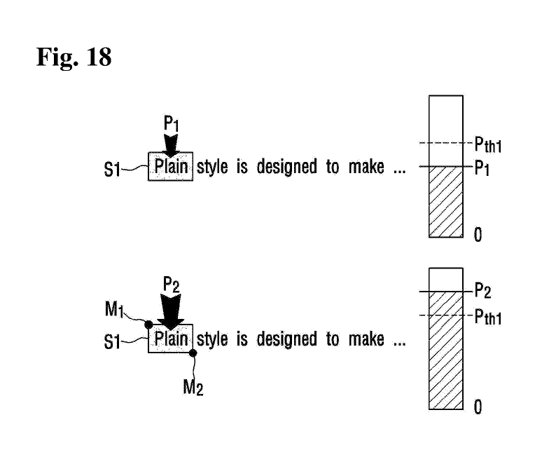

The step S1410 in which the controller 500 shown in FIG. 1 selects a predetermined character in the display of the touch input unit 100 will be described with reference to FIGS. 17 to 18.

FIG. 17 shows a state where an e-mail application has been executed on the display of the touch input unit 100. However, there is no limitation to this, and it should be noted that any application capable executing a selectable character “ch” on the display of the touch input unit 100 can be executed. For example, a social network service (SNS) application such as KakaoTalk, Line, Facebook, and WhatsApp, etc., can be executed.

Referring to FIG. 17, the controller 500 shown in FIG. 1 selects a predetermined character “ch” among various characters which are displayed on the display of the touch input unit 100. The predetermined character “ch” selected in FIG. 17 is one sentence. However, the character “ch” is not limited to this. The character “ch” may be one word, a plurality of words or symbols, or a plurality of sentences.

The controller 500 may designate the selected character “ch” as a selection area “S” and may display on the display of the touch input unit 100 so as to be distinguished from other remaining characters.

The controller 500 shown in FIG. 1 may detect the position and pressure of the touch input to the touch input unit 100 and may select the character “ch” on the basis of the detected position and pressure.

A method in which the controller 500 selects the character “ch” will be described with reference to FIG. 18.

Referring to FIGS. 17 and 18, when a portion (e.g., “Plain” as one word) of the character “ch” displayed on the display of the touch input unit 100 is touched by an object “f” by a first pressure “P1”, the controller 500 designates the touched portion as a first selection area “S1”. Here, the object “f” does not necessarily need to touch the whole of the portion (Plain). Even when the object “f” actually touches a portion (e.g., “1a”) of the portion (Plain), the portion (Plain) can be controlled to be selected.

Here, the first pressure “P1” has any value between a first reference pressure “Pth1” and 0. The first reference pressure “Pth1” is a standard for determining whether the touch on the display of the touch input unit 100 by the object “f” is a simple touch or a touch applying a pressure. The controller 500 of the touch input device determines that the touch of the object “f” is a general touch when the object “f” touches by a pressure less than first reference pressure “Pth1”, and determines that the touch of the object “f” is a touch applying a pressure when the object “f” touches by a pressure higher than first reference pressure “Pth1”.

After the first selection area “S1” is designated, when the object “f” presses the portion of the selected character “ch” for a predetermined time by a second pressure “P2” higher than the first pressure “P1”, the controller 500 controls such that a first moving cursor M1 is displayed in the top left corner of the first selection area “S1” on the display of the touch input unit 100, and a second moving cursor M2 is displayed in the bottom right corner of the first selection area “S1”. Here, the second pressure “P2” has any value which is higher than that of the first pressure “P1” and is higher than that of the first reference pressure “Pth1”.

Meanwhile, after the first selection area “S1” is designated, when the object “f” presses the portion of the selected character “ch” for a predetermined time instead of pressing the portion of the selected character “ch” for a predetermined time by a second pressure “P2” higher than the first pressure “P1”, the controller 500 may control such that the first moving cursor M1 is displayed in the top left corner of the first selection area “S1” on the display of the touch input unit 100, and the second moving cursor M2 is displayed in the bottom right corner of the first selection area “S1”. Here, the fact that the object “f” touches the portion of the selected character “ch” for a predetermined time means that the pressure value applied by the object “f” is between the first reference pressure “Pth1” and 0.

In a state where the first moving cursor M1 and the second moving cursor M2 are displayed on the first selection area “S1”, when the object “f” moves, as shown in FIG. 17, in a first direction D1 while touching the display, the controller 500 controls such that the second moving cursor M2 moves along the object “f” in the first direction D1. When the second moving cursor M2 is dragged by the object “f” and moves to the portion of the character “ch” at a position where the object “f” has stopped, the controller 500 controls such that the entire character “ch” is finally designated as the selection area “S”. Then, even though the object “f” separates from the touch input unit 100, the controller 500 controls such that the designated selection area “S” as it is covers the character “ch”. Here, the pressure by which the object “f” drags the second moving cursor M2 has a value between the first reference pressure “Pth1” and 0. That is, the controller 500 determines the moving of the object “f” in the first direction D1 by the pressure between the first reference pressure “Pth1” and 0 as dragging and controls the selection area “S” to be expanded.

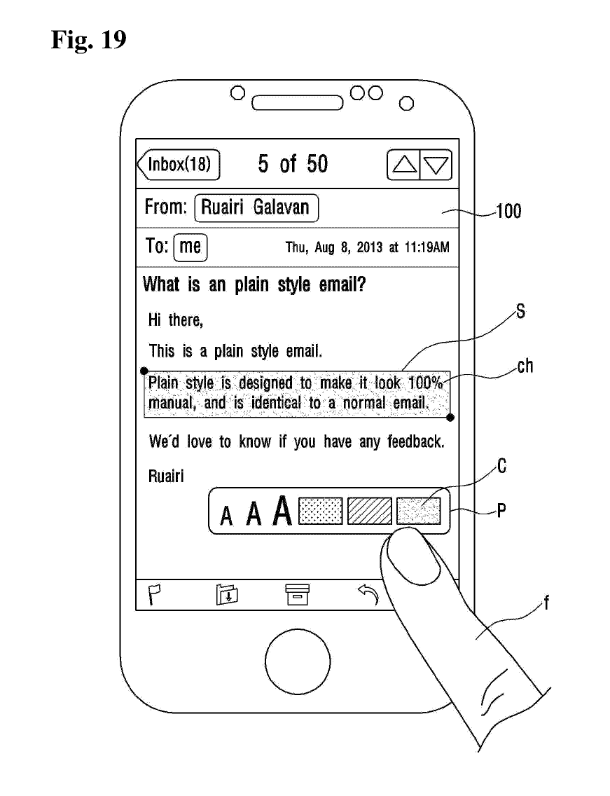

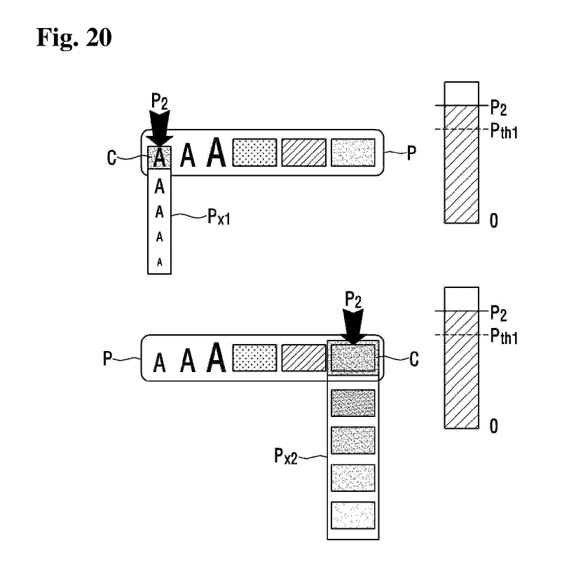

Referring back to FIG. 16, the step S1430 in which the controller 500 generates a pop-up window for changing the color and size of the selected predetermined character and displays the pop-up window on the display will be described with reference to FIGS. 19 to 20.

Referring to FIG. 19, when the predetermined character “ch” is designated as the selection area “S”, the controller 500 controls such that the pop-up window “P” is displayed on the display of the touch input unit 100.

After the predetermined character “ch” is designated as the selection area “S”, the controller 500 may control such that the pop-up window “P” is displayed on the display of the touch input unit 100 immediately after the object “f” separates from the touch input unit 100.

Meanwhile, after the predetermined character “ch” is designated as the selection area “S”, the controller 500 may control such that the pop-up window “P” is displayed on the display of the touch input unit 100 when the object “f” applies the second pressure “P2” to the touch input unit 100 in a state where the object “f” does not separate from the touch input unit 100.

The pop-up window “P” includes a plurality of size reference characters A, A, and A representing the size of the character “ch” to be changed, and includes at least two color selectors “c” displaying mutually different colors. The reference characters A, A, and A is predetermined or changeable. The color selector “c” is also predetermined or changeable.

After the pop-up window “P” is displayed on the display of the touch input unit 100, when the object “f” touches any one of the plurality of the size reference characters A, A, and A and/or any one of the plurality of the color selectors “c”, the controller 500 is able to immediately change the size or color of the character “ch” within the selection area “S” in response to the touch of the object “f”. Here, the touch of the object “f” may have a pressure value between the first reference pressure “Pth1” and 0 shown in FIG. 18.

When the pop-up window “P” is displayed on the display of the touch input unit 100, the object “f” may select at least one of the size and color of the character “ch” within the selection area “S” as a predetermined touch. If the object “f” selects the size of the character “ch” and does not select the color, the controller 500 determines that only the size of the character “ch” is changed and the color is maintained as it is. If the object “f” selects the color of the character “ch” and does not select the size, the controller 500 determines that the size of the character “ch” is maintained as it is and the color is changed into the selected color. Here, the controller 500 is able to determine that the object “f” does not select any one of the size and color when, for example, the object “f” touches other portions other than the pop-up window “P” on the display, or by counting the predetermined time.

Meanwhile, when the object “f” selects both of the size and color of the character “ch” within the predetermined time, the controller 500 may determine that both of the size and color of the character “ch” are changed.

An additional embodiment will be described with reference to FIG. 20.

Referring to FIG. 20, after the pop-up window “P” is displayed on the display of the touch input unit 100, when the object “f” presses any one among the reference characters A, A, and A and the color selectors “c” displayed in the pop-up window “P” by the second pressure “P2” higher than the first reference pressure “Pth1”, the controller 500 may control such that selection boxes Px1 and Px2 for any one among the reference characters A, A, and A and the color selector “c” is displayed on the display.

After the selection boxes Px1 and Px2 are displayed on the display, when the object “f” touches any one character or color within the selection boxes Px1 and Px2 by a pressure less than the first reference pressure “Pth1”, the controller 500 is able to immediately change the size and/or color of the selected character “ch” in response to the touch of the object “f”.

For example, when the object “f” presses any one (A) of the reference characters A, A, and A displayed in the pop-up window “P” by the second pressure “P2”, the controller 500 may control such that the first selection box Px1 for any one (A) of the reference characters A, A, and A is displayed on the display. The first selection box Px1 includes a plurality of the reference characters smaller than the selected reference character (A). The plurality of the reference characters may be listed in order of size. Then, when the object “f” touches any one character within the first selection box Px1, the controller 500 changes immediately the size of the selected character “ch” in response to the touch of the object “f”.

Here, though not shown in the drawing, the first selection box Px1 may include various fonts representing the selected reference character (A). For example, the first selection box Px1 may include Gothic font, Anal font, Tahoma font, etc.

For another example, when the object “f” presses any one of the color selectors “c” displayed in the pop-up window “P” by the second pressure “P2” higher than the first reference pressure “Pth1”, the controller 500 may control such that the second selection box Px2 for any one of the color selectors “c” is displayed on the display. The second selection box Px2 may include colors similar to the selected color, and the similar colors may be listed on the basis of brightness or saturation. Then, when the object “f” touches any one color within the second selection box Px2 by a pressure less than the first reference pressure “Pth1”, the controller 500 changes immediately the color of the selected character “ch” in response to the touch of the object “f”.

Meanwhile, in FIG. 20, it is assumed that when the object “f” presses any one of the reference characters A, A, and A displayed in the pop-up window “P” or any one of the color selectors “c” by the second pressure “P2”, the controller 500 displays the selection boxes Px1 and Px2 on the display. However, there is no limitation to this. For example, even when the object “f” touches any one of the reference characters A, A, and A displayed in the pop-up window “P” or any one of the color selectors “c” by a pressure less than the first reference pressure “Pth1”, the controller 500 may display the selection boxes Px1 and Px2 on the display.

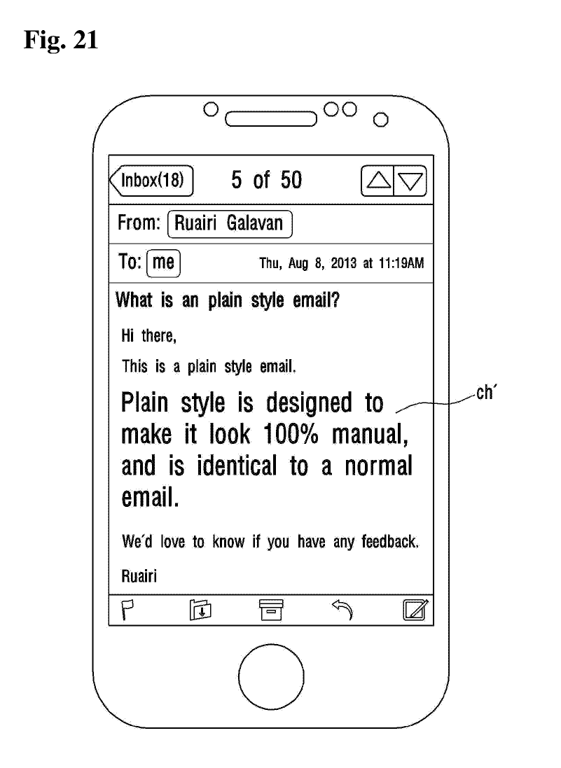

Referring back to FIG. 16, the step S1450 in which the controller 500 changes the color and size of the character into the color and size selected by the user and displays on the display will be described with reference to FIG. 21.

Referring to FIG. 21, the controller 500 changes the color and size of the character “ch′” into the color and size selected by the user and controls such that the changed character “ch′” is displayed on the display of the touch input unit 100.

Meanwhile, though not shown in the drawing, when the controller 500 designates the selection area “S” in FIG. 15, or when the controller 500 detects the second pressure “P2” in FIG. 18, or when the controller 500 displays the pop-up window “P” in FIG. 19, or when the controller 500 displays the selection boxes Px1 and Px2 in FIG. 20, the controller 500 may control such that the tactile sensation generator 700 shown in FIG. 1 generates a predetermined tactile output. Through the tactile output generated by the tactile sensation generator 700, the object “f” is able to immediately check whether or not a predetermined touch occurs as desired and a predetermined pressure is applied as desired.

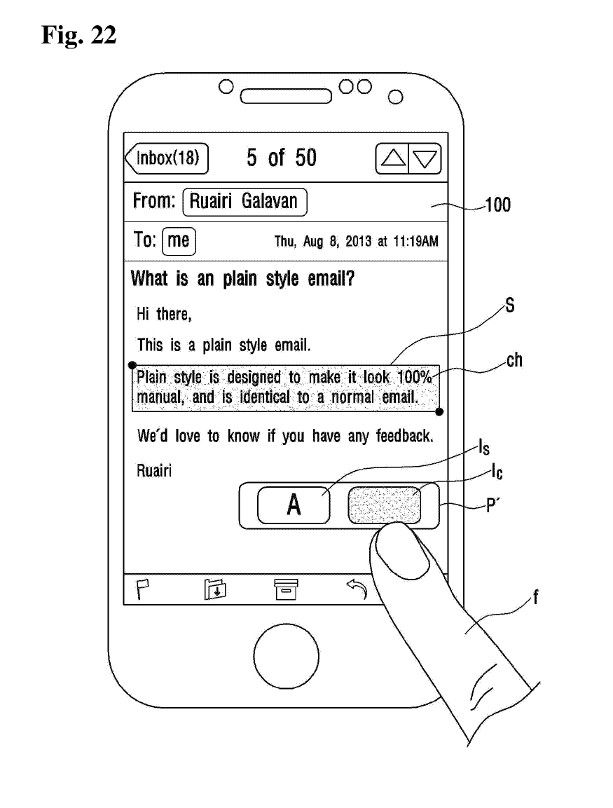

FIGS. 22 to 28 are views for describing another method shown in FIG. 16 for changing at least one of the size and color of the character displayed based on the touch pressure in accordance with the embodiment of the present invention.

Referring to FIG. 22, the controller 500 shown in FIG. 1 selects a predetermined character “ch” among various characters which are displayed on the display of the touch input unit 100. The predetermined character “ch” selected in FIG. 22 is one sentence. However, the character “ch” is not limited to this. The character “ch” may be one word, a plurality of words or symbols, or a plurality of sentences.

The controller 500 shown in FIG. 1 may designate the selected character “ch” as a selection area “S” and may display on the display of the touch input unit 100 so as to be distinguished from other remaining characters.

The controller 500 shown in FIG. 1 detects the position and pressure of the touch input to the touch input unit 100 and may select the character “ch” on the basis of the detected position and pressure. Since the method for selecting the character “ch” has been described in detail in FIG. 16, the description thereof will be omitted.

When the predetermined character “ch” is designated as the selection area “S”, the controller 500 shown in FIG. 1 controls such that a pop-up window “P′” is displayed on the display of the touch input unit 100.

After the predetermined character “ch” is designated as the selection area “S”, the controller 500 may control such that the pop-up window “P′” is displayed on the display of the touch input unit 100 immediately after the object “f” separates from the touch input unit 100.

Meanwhile, after the predetermined character “ch” is designated as the selection area “S”, the controller 500 may control such that the pop-up window “P′” is displayed on the display of the touch input unit 100 when the object “f” applies the second pressure “P2” higher than the first reference pressure to the touch input unit 100 in a state where the object “f” does not separate from the touch input unit 100.

The pop-up window “P′” includes a first selector “Is” for changing the size of the character “ch” and a second selector “Ic” for changing the color of the character “ch”. When the object “f” presses any one of the first selector “Is” and the second selector “Ic” by a pressure higher than the first reference pressure, the controller 500 shown in FIG. 1 changes the size or color of the character “ch” in response to the magnitude of the input pressure.

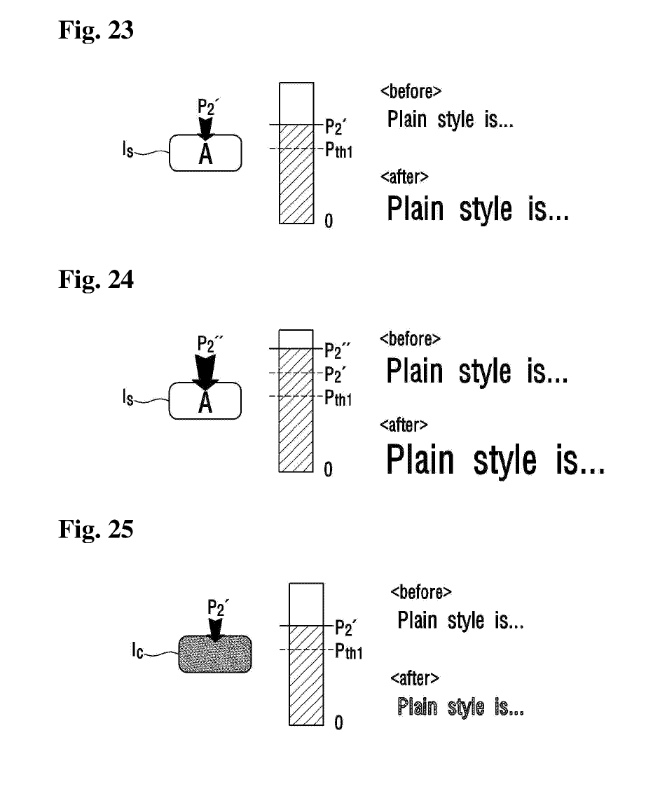

A method in which the controller 500 changes the size of the character “ch” in accordance with the magnitude of the pressure applied by the object “f” will be described with reference to FIGS. 23 to 24.

In FIG. 23, the size of the character “ch” immediately before the object “f” presses the first selector “Is” by the second pressure “P2′” is shown in <before>, and the changed size of the character “ch” immediately after the object “f” presses the first selector “Is” by the second pressure “P2′” is shown in <after>. Here, the second pressure “P2′” is higher than the first reference pressure “Pth1”.

In FIG. 24, the size of the character “ch” in a state where the object “f” presses the first selector “Is” by the second pressure “P2′” is shown in <before>, and the changed size of the character “ch” immediately after the object “f” presses the first selector “Is” by the second pressure “P2″” is shown in <after>. Here, the second pressure “P2′” is higher than the first reference pressure “Pth1” and is higher than the second pressure “P2′”.

As shown in FIG. 23, when the object “f” presses the first selector “Is” which is displayed on the touch input unit 100 shown in FIG. 1 by the second pressure “P2′”, the controller 500 detects the magnitude of the second pressure “P2′” applied by the object “f” and changes the size of the selected character “ch” in response to the detected magnitude of the second pressure “P2′”. Here, what the size of the selected character “ch” is changed in response to the detected magnitude of the second pressure “P2′” may mean, for example, that the controller 500 changes the size of the character “ch” corresponding to the magnitude of the second pressure “P2′” with reference to a predetermined table. Here, the size of the character “ch” according to the magnitude of the pressure may be defined in the table.

As shown in FIG. 24, when the object “f” presses the first selector “Is” by the second pressure “P2″” higher than the second pressure “P2′” shown in FIG. 23, the controller 500 shown in FIG. 1 controls the size of the selected character “ch” to be larger than that of the changed character “ch” shown in FIG. 23 in response to the detected magnitude of the second pressure “P2″”.

When the detected magnitude of the pressure of the object “f” becomes gradually greater, the controller 500 shown in FIG. 1 may control the size of the selected character “ch” to be continuously or discontinuously changed to become gradually larger in response to the magnitude of the pressure. Also, when the detected magnitude of the pressure of the object “f” is increased and then decreased, the controller 500 may control the size of the selected character “ch” to become larger and then smaller in response to the magnitude of the pressure.

When the detected magnitude of the pressure of the object “f” is maintained for a predetermined time, the controller 500 shown in FIG. 1 may change the size of the character “ch” into a size corresponding to the maintained magnitude of the pressure immediately after the predetermined time.

Here, the fact that the object “f” uniformly maintains the predetermined pressure for the predetermined time means that the magnitude of the pressure applied by the object “f” has a value within a predetermined error range.

Right after the predetermined time, the controller 500 shown in FIG. 1 may not only change the size of the character “ch” into a size corresponding to the maintained magnitude of the pressure, but also control the pop-up window “P′” to disappear from the display.

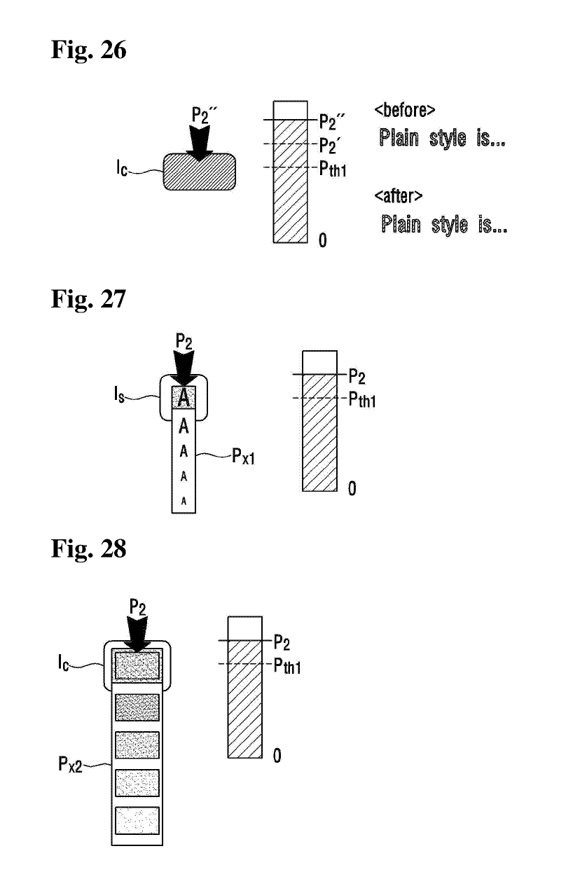

A method in which the controller 500 changes the color of the character “ch” in accordance with the magnitude of the pressure applied by the object “f” will be described with reference to FIGS. 25 to 26.

In FIG. 25, the color of the character “ch” immediately before the object “f” presses the second selector “Ic” by the second pressure “P2′” is shown in <before>, and the changed color of the character “ch” immediately after the object “f” presses the second selector “Ic” by the second pressure “P2′” is shown in <after>. Here, the second pressure “P2′” is higher than the first reference pressure “Pth1”.

In FIG. 26, the color of the character “ch” in a state where the object “f” presses the second selector “Ic” by the second pressure “P2′” is shown in <before>, and the changed color of the character “ch” immediately after the object “f” presses the second selector “Ic” by the second pressure “P2″” is shown in <after>. Here, the second pressure “P2″” is higher than the first reference pressure “Pth1” and is higher than the second pressure “P2′”.

As shown in FIG. 25, when the object “f” presses the second selector “Ic” which is displayed on the touch input unit 100 shown in FIG. 1 by the second pressure “P2′”, the controller 500 detects the magnitude of the second pressure “P2′” applied by the object “f” and changes the color of the selected character “ch” in response to the detected magnitude of the second pressure “P2′”. Here, what the color of the selected character “ch” is changed in response to the detected magnitude of the second pressure “P2′” may mean, for example, that the controller 500 changes the color of the character “ch” corresponding to the magnitude of the second pressure “P2′” with reference to a predetermined table. Here, the color of the character “ch” according to the magnitude of the pressure may be defined in the table.

As shown in FIG. 26, when the object “f” presses the second selector “Ic” by the second pressure “P2″” higher than the second pressure “P2′” shown in FIG. 25, the controller 500 shown in FIG. 1 controls the color of the selected character “ch” to be changed into a color different from the color of the changed character “ch” shown in FIG. 25 in response to the detected magnitude of the second pressure “P2″”.

When the detected magnitude of the pressure of the object “f” becomes gradually greater, the controller 500 shown in FIG. 1 may control the color of the selected character “ch” to be continuously or discontinuously changed differently in response to the magnitude of the pressure.

When the detected magnitude of the pressure of the object “f” is maintained for a predetermined time, the controller 500 shown in FIG. 1 may change the color of the character “ch” into a color corresponding to the maintained magnitude of the pressure immediately after the predetermined time.

Here, the fact that the object “f” uniformly maintains the predetermined pressure for the predetermined time means that the magnitude of the pressure applied by the object “f” has a value within a predetermined error range.

Right after the predetermined time, the controller 500 shown in FIG. 1 may not only change the size of the character “ch” into a size corresponding to the maintained magnitude of the pressure, but also control the pop-up window “P′” to disappear from the display.

Another method in which the controller 500 changes the size and/or color of the character “ch” in accordance with the magnitude of the pressure applied by the object “f” will be described with reference to FIGS. 27 to 28.

Referring to FIGS. 22, 27, and 28, after the pop-up window “P′” is displayed on the display of the touch input unit 100, when the object “f” presses any one of the first selector “Is” and the second selector “Ic” displayed in the pop-up window “P′” by the second pressure “P2” higher than the first reference pressure “Pth1”, the controller 500 may control such that selection boxes Px1 and Px2 for any one of the first selector “Is” and the second selector “Ic” is displayed on the display.

After the selection boxes Px1 and Px2 are displayed on the display, when the object “f” touches any one character or color within the selection boxes Px1 and Px2 by a pressure less than the first reference pressure “Pth1”, the controller 500 is able to immediately change the size and/or color of the selected character “ch” in response to the touch of the object “f”.

For example, as shown in FIG. 27, when the object “f” presses the first selector “Is” displayed in the pop-up window “P′” by the second pressure “P2”, the controller 500 may control such that the first selection box Px1 for first selector “Is” is displayed on the display. The first selection box Px1 may include a plurality of the reference characters smaller than the reference character (A) displayed in the first selector “Is”. The plurality of the reference characters may be listed in order of size. Then, when the object “f” touches any one character within the first selection box Px1, the controller 500 changes immediately the size of the selected character “ch” in response to the touch of the object “f”.

Here, though not shown in the drawing, the first selection box Px1 may include various fonts representing the selected reference character (A). For example, the first selection box Px1 may include Gothic font, Anal font, Tahoma font, etc.

For another example, as shown in FIG. 28, when the object “f” presses the second selector “Ic” displayed in the pop-up window “P′” by the second pressure “P2” higher than the first reference pressure “Pth1”, the controller 500 may control such that the second selection box Px2 for the second selector “Ic” is displayed on the display. The second selection box Px2 may include colors different from the color displayed in the second selector “Ic”, and the different colors may be listed on the basis of brightness or saturation. Then, when the object “f” touches any one color within the second selection box Px2 by a pressure less than the first reference pressure “Pth1”, the controller 500 changes immediately the color of the selected character “ch” in response to the touch of the object “f”.

Meanwhile, in FIGS. 27 and 28, it is assumed that when the object “f” presses any one of the first selector “Is” and the second selector “Ic” displayed in the pop-up window “P′” by the second pressure “P2” higher than the first reference pressure “Pth1”, the controller 500 displays the selection boxes Px1 and Px2 on the display. However, there is no limitation to this. For example, even when the object “f” touches any one of the first selector “Is” and the second selector “Ic” displayed in the pop-up window “P′” or any one of the color selectors “c” by a pressure less than the first reference pressure “Pth1”, the controller 500 may display the selection boxes Px1 and Px2 on the display.

Referring back to FIG. 22, the controller 500 shown in FIG. 1 may remove the pop-up window “P′” by a predetermined operation by the object “f”. For example, when the object “f” touches other portions other than the pop-up window “P′” by a pressure less than the first reference pressure “Pth1”, the controller 500 may control the pop-up window “P′” to be removed.

As shown in FIGS. 1 to 28, according to the embodiment of the present invention, the method for changing the size and color of the character in accordance with the touch pressure, and the touch input device thereof are able to execute various applications by using a new touch method based on the touch pressure. In particular, it is possible to selectively change the size and color of a predetermined character in accordance with the pressure magnitude of a touch on the touch input device, touch direction and/or a combination of touch positions.

The features, structures and effects and the like described in the embodiments are included in an embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although the embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

What is claimed is:

1. A method for changing the size and color of a character in a touch input device comprising a controller and a touch input unit, the method comprising:
selecting, by the controller, a predetermined character in a display of the touch input unit;
generating, by the controller, a pop-up window for changing at least one of the color and size of the selected predetermined character and displaying the generated pop-up window on the display; and
changing, by the controller, at least one of the color and size of the selected character into at least one of the color and size selected by an object, and displaying the changed character on the display.

2. The method of claim 1, wherein, in the generating and displaying the pop-up window, when the object separates from the touch input unit after the character is selected, the controller displays the pop-up window on the display of the touch input unit.

3. The method of claim 1, wherein, in the generating and displaying the pop-up window, when the object presses the display of the touch input unit by a pressure higher than a first reference pressure after the character is selected, the controller displays the pop-up window on the display of the touch input unit.

4. The method of claim 1, wherein the pop-up window comprises a plurality of size reference characters representing the size of the selected character and comprises at least two color selectors displaying mutually different colors.

5. The method of claim 4, wherein, when the object presses any one among the reference characters and the color selectors which are displayed in the pop-up window by a pressure higher than a first reference pressure, the controller displays a selection box for any one among the reference characters and the color selectors on the display of the touch input unit.

6. The method of claim 4, wherein, when the object touches any one among the reference characters and the color selectors which are displayed in the pop-up window by a pressure less than a first reference pressure, the controller displays a selection box for any one among the reference characters and the color selectors on the display of the touch input unit.

7. The method of claim 5, wherein the selection box comprises a plurality of the reference characters smaller than the reference character selected by the object, and the plurality of the reference characters are listed in order of size.

8. The method of claim 5, wherein the selection box comprises various fonts representing the reference character selected by the object.

9. The method of claim 5, wherein the selection box comprises colors similar to the color selected by the object, and the similar colors are listed on the basis of brightness or saturation.

10. The method of claim 1,
wherein the pop-up window comprises a selector for changing the size or color of the selected character; and
wherein, when the object presses the selector by a pressure higher than a first reference pressure, the controller changes the size or color of the character in response to the magnitude of the pressure applied by the object.

11. The method of claim 10, wherein, when the object maintains the pressure higher than the first reference pressure for a predetermined time, the controller changes the size or color of the character into a size or color corresponding to the magnitude of the pressure higher than the first reference pressure immediately after the predetermined time.

12. The method of claim 1,
wherein the pop-up window comprises a selector for changing the size or color of the selected character; and
wherein, when the object presses the selector displayed in the pop-up window by a pressure higher than a first reference pressure, the controller displays a selection box for the selector on the display of the touch input unit.

13. The method of claim 1,
wherein the pop-up window comprises a selector for changing the size or color of the selected character; and
wherein, when the object touches the selector displayed in the pop-up window by a pressure less than a first reference pressure, the controller displays a selection box for the selector on the display of the touch input unit.

14. The method of claim 12, wherein, when the object touches any one character or color within the selection box, the controller changes the size or color of the selected character.

15. The method of claim 12, wherein the selection box comprises a plurality of reference characters smaller than a reference character displayed in the selector, and the plurality of the reference characters are listed in order of size.

16. The method of claim 12, wherein the selection box comprises various fonts representing a reference character displayed in the selector.

17. The method of claim 12, wherein the selection box comprises colors different from the color displayed in the selector, and the different colors are listed on the basis of brightness or saturation.

18. The method of claim 13, wherein, when the object touches any one character or color within the selection box, the controller changes the size or color of the selected character.

19. The method of claim 13, wherein the selection box comprises a plurality of reference characters smaller than a reference character displayed in the selector, and the plurality of the reference characters are listed in order of size.

20. The method of claim 13, wherein the selection box comprises various fonts representing a reference character displayed in the selector.
